(19) United States
(12) Patent Application Publication
(10) Pub. No.: US 2025/0068030 A1
(43) Pub. Date: Feb. 27, 2025

(54) FIBER-OPTIC NONLINEAR WAVELENGTH CONVERTER

(71) Applicant: The Board of Trustees of the University of Illinois, Urbana, IL (US)

(72) Inventor: Haohua Tu, Savoy, IL (US)

(21) Appl. No.: 18/815,471

(22) Filed: Aug. 26, 2024

Related U.S. Application Data
(60) Provisional application No. 63/578,759, filed on Aug. 25, 2023.

(51) Int. Cl. G02F 1/35; G02F 1/365

(52) U.S. Cl. CPC G02F 1/3528; G02F 1/365

(57) ABSTRACT

A tunable and reliable accessory for femtosecond ytterbium fiber chirped pulse amplifiers is developed, termed as fiber-optic nonlinear wavelength converter (FNWC), as an adaptive optical source for femtosecond biophotonics. This accessory empowers the laser to produce fiber delivered ˜20 nJ pulses with central wavelength across 950-1150 nm, repetition rate across 1-10 MHz, and pulse width across 40-400 fs. One enabling feature is the surprising suppression of the long-term fiber photodamage in coherent supercontinuum generation using a photonic crystal fiber with large-pitch small-hole lattice. The corresponding integrated laser may widen the access to tunable ultrafast laser technology in biology and medicine.

### CROSS-REFERENCE TO RELATED APPLICATIONS

This application claims priority to and the benefit of U.S. Provisional Application No. 63/578,759, filed Aug. 25, 2023 and titled “Fiber-Optic Nonlinear Wavelength Converter,” the entire contents of which are herein incorporated by reference for all purposes.

### STATEMENT REGARDING FEDERALLY SPONSORED RESEARCH OR DEVELOPMENT

This invention was made with government support under CA241618 awarded by the National Institutes of Health. The government has certain rights in the invention.

### TECHNICAL FIELD

The present disclosure is directed to optical sources. More particularly, the present disclosure is directed to an accessory for femtosecond pulse amplifiers, as an adaptive optical source for femtosecond biophotonics.

### BACKGROUND

In comparative examples, laser engineering has produced mode-locked optical pulses with (sub-) picosecond duration at a megahertz-level repetition rate. Broad and safe access to ultrafast laser technology has been hindered by the absence of optical fiber-delivered pulses with a tunable central wavelength, pulse repetition rate, and pulse width in the picosecond-femtosecond regime.

### SUMMARY

The present disclosure addresses these and other shortcomings of the comparative art by presenting, in an example, a tunable and reliable accessory for femtosecond ytterbium fiber chirped pulse amplifiers, termed a fiber-optic nonlinear wavelength converter (FNWC), as an adaptive optical source for femtosecond biophotonics. In one particular example, this accessory empowers the laser to produce fiber delivered pulses with pulse energy (E) of ˜20 nJ and central wavelength (2) across 950-1150 nm, repetition rate (f) across 1-10 MHz, and pulse width (t) across 40-400 fs. One advantageous feature is the suppression of the long-term fiber photodamage in coherent supercontinuum generation using a photonic crystal fiber with large-pitch small-hole lattice. The corresponding integrated laser may widen the access to tunable ultrafast laser technology in biology and medicine.

According to one aspect of the present disclosure, an optical source is provided. The optical source comprises a supercontinuum generating unit including a photonic crystal fiber having, in cross-section, a lattice of holes respectively separated by a pitch, wherein the pitch is three or more times greater than a diameter of the holes, and wherein a length of the photonic crystal fiber is approximately equal to a period of a long-period fiber grating of an input end of the photonic crystal fiber defined by its cross section; a pulse shaper or dispersion compensation unit configured to shape or compress an output pulse of the supercontinuum generating unit; and an optical output configured to generate an output radiation.

According to another aspect of the present disclosure, a microscopy system is provided. The microscopy system comprises a laser source configured to generate an input radiation; a nonlinear wavelength converter including a supercontinuum generating unit configured to receive the input radiation, the supercontinuum generating unit including a photonic crystal fiber having, in cross-section, a lattice of holes respectively separated by a pitch, wherein the pitch is three or more times greater than a diameter of the holes, and wherein a length of the photonic crystal fiber is approximately equal to a period of a long-period fiber grating of an input end of the photonic crystal fiber defined by its cross section, a pulse shaper or dispersion compensation unit configured to shape or compress an output pulse of the supercontinuum generating unit, and an optical output configured to generate an output radiation; and a hollow-core fiber configured to optically couple the output radiation to an optical device.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates approaches for fiber supercontinuum generation according to comparative examples and according to an aspect of the present disclosure.

FIG. 2 illustrates an example of an optical system according to an aspect of the present disclosure.

FIG. 3A illustrates example images captured by an optical system according to an aspect of the present disclosure.

FIG. 3B illustrates example images captured by an optical system according to an aspect of the present disclosure.

FIG. 4 illustrates an example of an optical system according to an aspect of the present disclosure.

FIG. 5 illustrates example images captured by an optical system according to an aspect of the present disclosure.

FIG. 6 illustrates example images captured by an optical system according to an aspect of the present disclosure.

FIG. 7 illustrates example images captured by an optical system according to an aspect of the present disclosure.

FIG. 8 illustrates example images captured by an optical system according to an aspect of the present disclosure.

FIG. 9A illustrates example images captured by an optical system according to an aspect of the present disclosure.

FIG. 9B illustrates example images captured by an optical system according to an aspect of the present disclosure.

FIG. 9C illustrates example images captured by an optical system according to an aspect of the present disclosure.

FIG. 9D illustrates example images captured by an optical system according to an aspect of the present disclosure.

FIG. 9E illustrates example images captured by an optical system according to an aspect of the present disclosure.

FIG. 9F illustrates example images captured by an optical system according to an aspect of the present disclosure.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various aspects of the present disclosure. However, it will be apparent to those skilled in the art that the various features, concepts, and aspects described herein may be implemented and practiced without these specific details.

The present disclosure may be implemented on or with the use of computing devices including control units, processors, and/or memory elements in some examples. As used herein, a “control unit” may be any computing device configured to send and/or receive information (e.g., including instructions) to/from various systems and/or devices. A control unit may comprise processing circuitry configured to execute operating routine(s) stored in a memory. The control unit may comprise, for example, a processor, microcontroller, application-specific integrated circuit (ASIC), field-programmable gate array (FPGA), and the like, any other digital and/or analog components, as well as combinations of the foregoing, and may further comprise inputs and outputs for processing control instructions, control signals, drive signals, power signals, sensor signals, and the like. All such computing devices and environments are intended to fall within the meaning of the term “controller,” “control unit,” “processor,” or “processing circuitry” as used herein unless a different meaning is explicitly provided or otherwise clear from the context. The term “control unit” is not limited to a single device with a single processor, but may encompass multiple devices (e.g., computers) linked in a system, devices with multiple processors, special purpose devices, devices with various peripherals and input and output devices, software acting as a computer or server, and combinations of the above. In some implementations, the control unit may be configured to implement cloud processing, for example by invoking a remote processor.

Moreover, as used herein, the term “processor” may include one or more individual electronic processors, each of which may include one or more processing cores, and/or one or more programmable hardware elements. The processor may be or include any type of electronic processing device, including but not limited to central processing units (CPUs), graphics processing units (GPUS), ASICs, FPGAs, microcontrollers, digital signal processors (DSPs), or other devices capable of executing software instructions. When a device is referred to as “including a processor,” one or all of the individual electronic processors may be external to the device (e.g., to implement cloud or distributed computing). In implementations where a device has multiple processors and/or multiple processing cores, individual operations described herein may be performed by any one or more of the microprocessors or processing cores, in series or parallel, in any combination.

As used herein, the term “memory” may be any storage medium, including a non-volatile medium, e.g., a magnetic media or hard disk, optical storage, or flash memory, including read-only memory (ROM), electrically programmable ROM (EPROM), electrically erasable programmable ROM (EEPROM); a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc.; on-chip memory; and/or an installation medium where appropriate, such as software media, e.g., a CD-ROM, a DVD-ROM, a Blu-ray disc, or floppy disks, on which programs may be stored and/or data communications may be buffered. The term “memory” may also include other types of memory or combinations thereof. For the avoidance of doubt, cloud storage is contemplated in the definition of memory.

Before any aspects of the invention are explained in detail, it is to be understood that the invention is not limited in its application to the details of construction and the arrangement of components set forth in the following description or illustrated in the following drawings. The invention is capable of other aspects and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

It is also to be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed or that the first element must precede the second element in some manner.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “one of,” “only one of,” or “exactly one of.”

The present disclosure includes a description of various methods. For any methods described, regardless of whether the method is described in conjunction with a flow diagram, it should be understood that unless otherwise specified or required by context, any explicit or implicit ordering of steps performed in the execution of a method does not necessarily imply that those steps must be performed in the order presented, but instead the steps may be performed in a different order and/or in parallel.

The following discussion is presented to enable a person skilled in the art to make and use aspects of the invention. Various modifications to the illustrated aspects will be readily apparent to those skilled in the art, and the generic principles herein can be applied to other aspects and applications without departing from aspects of the invention. Thus, aspects of the invention are not intended to be limited to aspects shown but are to be accorded the widest scope consistent with the principles and features disclosed herein. The following detailed description is to be read with reference to the figures, in which like elements in different figures have like reference numerals. The figures, which are not necessarily to scale, depict selected aspects and are not intended to limit the scope of aspects of the invention. Skilled artisans will recognize the examples provided herein have many useful alternatives and fall within the scope of aspects of the invention.

Ultrafast laser engineering has produced mode-locked optical pulses with (sub-) picosecond duration (τ) at a MHz-level repetition rate (f) and driven the emergent field of femtosecond biophotonics. These ultrashort pulses were first produced after the invention of laser. Subsequently, the Ti:sapphire crystal was recognized as a better lasing medium than dye solutions to support a broad range of near-infrared wavelengths (λ). The development of Kerr lens mode-locking led to the commercialization of high average power (P) Ti:sapphire lasers tunable across 690-1020 nm. Other comparative examples have resulted in an ytterbium-based optical parametric oscillator (OPO) with one output widely tunable across 680-1300 nm and another synergistic output fixed at ˜ 1040 nm. Automatic wavelength tuning, beam pointing correction, and dispersion compensation have enabled many aspects of femtosecond biophotonics, including biological microscopy or clinical imaging, nanosurgery, and optogenetics. However, despite development in solid-state ultrafast sources, it remains technically challenging to independently and widely tune the three pulse parameters of λ, f, and τ with sufficient output P or pulse energy (E). In particular, the typical inability in comparative devices to vary f not only limits the solid-state ultrafast lasers themselves, but also the subsequent wavelength-tuning accessories of optical parametric amplifier (OPA).

In contrast to the solid-state lasers, ultrafast fiber lasers have played a relatively minor role in femtosecond biophotonics despite advances, largely due to the difficulty to tune λ (and to a lesser degree, t toward shorter durations). The fiber chirped pulse amplification (FCPA) of a pulse-picked seed along a large-core ytterbium (Yb) gain fiber, which could be either a conventional circular fiber or a largely single-mode photonic crystal fiber such as DC-200/40-PZ-Yb (NKT photonics), has led to various commercial FCPA lasers useful for LASIK eye surgery and material processing. Table 1 presents examples of such lasers.

TABLE 1
Representative commercial Yb-based pp-FCPA
lasers and, where used, OPA accessories

| | λ, f, and τ | | λ, f, and τ |
|---|---|---|---|
| Model (vendor) | (low-bound)* | P | from OPA |
| Satsuma | 1030 nm, 0.5-40 MHz, | 5/10/20 W | Niji: 257-4000 nm, |
| (Amplitude) | 300 fs | | 0.5-2 MHz, 50 fs |
| Y-Fi | 1035 nm, 1-10 MHz, | 3-20 W | Yi-F OPA: 1275- |
| (Thorlabs) | 220 fs | | 1800 nm, 1-3 MHz, |
| | | | 100 fs |
| Spirit 1030 | 1030, 1-30 MHz, | 70/100/140 W | NOPA-VISIR: 650- |
| (Newport) | 400 fs | (water cooled) | 900 & 1200-2500 |
| | | | nm, 1-4.3 MHz, 70 fs |
| Monaco | 1035 nm, 1-50 MHz, | 40/60 W | Opera-F: 650-900 & |
| (Coherent) | 350 fs | (water cooled) | 1200-2500 nm, 1-4 |
| | | | Mhz, 70 fs |
| FemtoFibe vario | 1030 nm, 1-10 MHz, | 8 W | N.A. |
| 1030 HP | 250 fs | | |
| (Toptica) | | | |
| Impulse | 1030 nm, 2-25 MHz, | 20 W | N.A. |
| (Clark-MXR) | 250 fs | | |
| BlueCut | 1030 nm, 1-10 MHz, | 10 W | N.A. |
| (Menlosystem) | 400 fs | | |
| FCPA-DE | 1045 nm, 1-5 MHz, | 20 W | N.A. |
| (IMRA) | 400 fs | | |

*Pulse width of sech²-profile that can be tuned (stretched) to several ps (up-bound) by a grating compressor.

These pulse-picked FCPA (pp-FCPA) lasers provide some advantages over the solid-state lasers due to the relative ease to vary fat the same P, i.e., pre-amplification pulse picking for variable E. It seems that pairing one pp-FCPA laser with an OPA accessory would empower the tuning of λ and τ (see Table 1) to compete favorably with the solid-state lasers. However, the OPA is a largely free-space add-on that diminishes the fiber-optic advantages of the pp-FCPA laser, e.g., high resistance to environmental disturbance and good beam quality ensured by single-mode fiber propagation. Also, routine operation and maintenance of an integrated FCPA-OPA laser is often beyond the expertise of a life scientist. Thus, the comparative tuning accessory based on OPA technology has limited the application of the otherwise attractive pp-FCPA lasers to compete with their solid-state counterparts. To overcome these OPA-related limitations, the present disclosure develops an alternative tuning accessory based on the seeding subunit of OPA technology, known as supercontinuum (or white-light) generation.

In comparative examples, bulk-medium supercontinuum generation was demonstrated in glasses using ps pulses. Later, fs pulses were more useful in the seed generation of commercial OPA operated at 0.25 MHz (see Table 2), which also enabled the commercial OPA accessories of the pp-FCPA lasers toward larger f of ˜4 MHZ (Table 1).

TABLE 2
Representative supercontinuum generation
in bulk media and photonic crystal fibers

| Input λ, f, and τ, | Coupled | Interactive medium | |
|---|---|---|---|
| respectively | P (or E) | (diameter, length) | Feature/comment |
| 530 nm, Q-switch, | (5 mJ) | Bulk glass | Discovery of supercontinuum |
| 4-8 ps | | (1.2 mm, 2-1000 mm) | generation under self-focusing |
| 800 nm, 0.25 MHz, | 0.25 W | Sapphire plate | Bulk supercontinuum |
| 170 fs | (1 μJ) | (~20 μm, <500 μm) | generation employed in |
| | | | commercial OPA |
| 770 nm, ~80 MHz, | (0.2 nJ) | Photonic crystal fiber | Widely accessible single-mode |
| 100 fs | | (1.7 μm, 10 cm) | fiber supercontinuum |
| | | | generation. |
| 1070 nm, 40 MHz, | 1.5 W | Photonic crystal fiber | Commercial all-fiber |
| 3.3 ps | | (4 μm, 5-65 m) | supercontinuum generation for |
| | | | the broadest spectra |
| 1030 nm, 10 MHz, | 1.8 W | Photonic crystal fiber | High peak-power coherent fiber |
| 300 fs | | (15 μm, 9 cm) | supercontinuum generation |

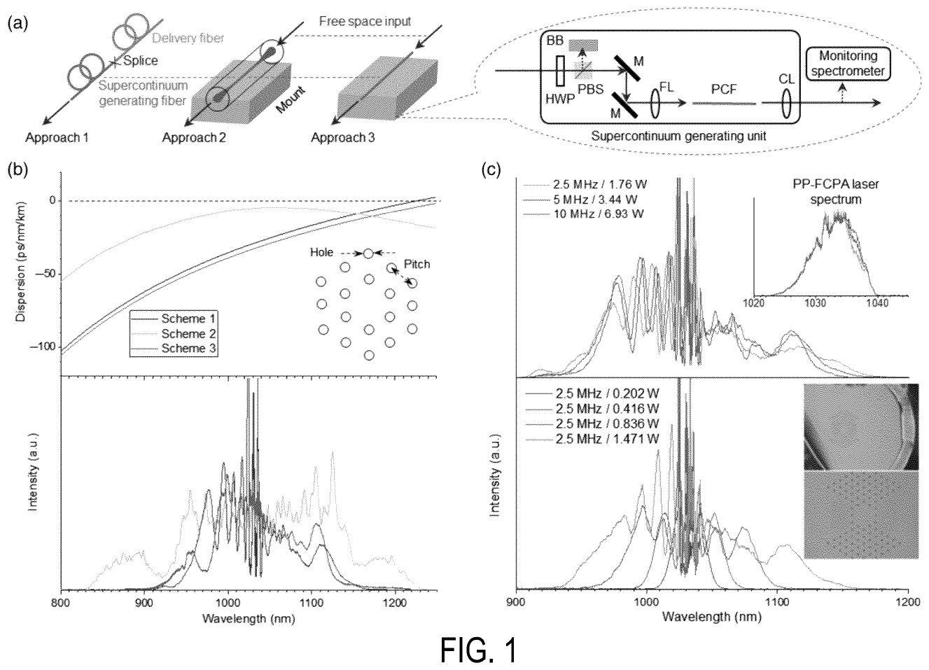

Photonic crystal fiber-based supercontinuum generation was first demonstrated using fs pulses, but ps pulses gained commercial success later due to its robust all-fiber setup. Approach 1 in FIG. 1 inset (a) and Table 2 illustrate this modality. In particular, inset (a) of FIG. 1 illustrates three general approaches for fiber supercontinuum generation: all-fiber splice often used in commercial supercontinuum lasers (Approach 1), commercial enclosed device with fiber capping and mode expansion as an add-on nonlinear wavelength converter for a Ti:sapphire oscillator (Approach 2), and mounted bare (polarization-maintaining) fiber for coherent fiber supercontinuum generation by a fs Yb:fiber laser (Approach 3). In FIG. 1, PP-FCPA refers to a pulse-picked fiber chirped pulse amplifier, BB refers to a beam blocker, HWP refers to a halfwave plate, PBS refers to a polarizing beam splitter, M refers to a mirror, FL refers to a focusing lens, PCF refers to a photonic crystal fiber, and CL refers to a collimating lens. Inset (b) shows three schemes of polarized coherent fiber supercontinuum generation for comparison with wavelength-dependent dispersion of photonic crystal fibers indicative of the restriction of supercontinuum generation to fiber normal dispersion regimes (top) with cross-sectional image of photonic crystal fibers indicative of pitch and hole sizes (inset), and corresponding spectra of supercontinuum outputs (bottom). Inset (c) shows graphs of output spectra at different f but the same E for Scheme 3 (top) in comparison with input spectra of source laser (inset), and output spectra at different E but the same f for Scheme 3 (bottom) with cross sectional images of the supercontinuum generating fiber (insct).

The success of the ps approach (Approach 1) in wide spectral broadening has largely restricted the fs approach to an add-on nonlinear wavelength converter for a solid-state Ti:sapphire oscillator in comparative examples (Approach 2). A third approach has diverged from either the all-fiber supercontinuum generation or the solid-state laser, and instead focused on coherent fiber supercontinuum generation by a fs Yb:fiber laser free of the pulse picking and a bare fiber several cm in length (Approach 3). Despite these progresses, the corresponding nonlinear fibers according to the comparative examples have a relatively small core (<12 μm) and do not support high-peak power coherent fiber supercontinuum generation by the pp-FCPA lasers (Table 1). In this context, there have been attempts to use a pp-FCPA laser (Satsuma, Amplitude) and a large-core (15 μm) photonic crystal fiber (LMA-PM-15, NKT Photonics), and subsequently to develop the alternative tuning accessory (Table 2).

However, according to the comparative examples, the corresponding supercontinuum generating fiber inevitably suffers irreversible photodamage after ˜100 hours of accumulative operation. This disruption prohibits the operation of the corresponding supercontinuum laser by a life scientist without extensive laser training. There thus exists a need to identify the nature of this long-term photodamage and then avoid it. It was therefore examined whether this photodamage was caused by airborne contaminant in a non-clean-room environment and/or high peak-intensity free-space coupling at two fiber end facets, which could be avoided by commercial photonic crystal fiber end-capping/termination with specific hole collapsing and beam expansion (FIG. 1, Approach 2), or other more complicated mechanisms.

A custom-built coherent fiber supercontinuum source (FIG. 1, Approach 3; Table 3, Scheme 1) enabled slide-free histochemistry, nonlinear optogenetics, and label-free imaging of extracellular vesicles. The supercontinuum output along one principal axis of polarization-maintaining (PM) LMA-PM-15 fiber with a high polarization extinction ratio (PER) reproducibly exhibited the same spectrum (FIG. 1, inset (b), Scheme 1) for different cleaved 25-cm fiber pieces (Table 3), as asserted by a deterministic model taking account of polarization effect.

TABLE 3
Three schemes of polarized coherent fiber supercontinuum in this study

| | Scheme 1 | | Scheme 2 | | Scheme 3 | |
|---|---|---|---|---|---|---|
| Master laser | Satsuma 10W | | Satsuma 10W | | | |
| (vendor) | (Amplitude) | | (Amplitude) | | | |
| Input (λ, f, and τ)* | 1030 nm, 10 MHz, | | 1031 nm, 40 MHz, | | 1031 nm, 5 MHz, | |
| | 280 fs | | 290 fs | | 290 fs | |
| Photonic crystal | LMA-PM-15 | | NL-1050-NEG-PM | | LMA-PM-40-FUD | |
| fiber (vendor) | (NKT Photonics) | | (custom, NKT | | (NKT Photonics) | |
| | | | Photonics) | | | |
| Core diameter | 14.8 μm | | 2.4 μm | | 40 μm | |
| (mode field | (12.6 μm @1064 nm) | | (2.2 μm @1064 nm) | | (32 μm @1064 nm) | |
| diameter) | | | | | | |
| Hole/pitch size; | 4.9/9.8 μm; | | 0.65/1.44 μm; | | 7/26 μm; | |
| cladding diameter | 230 μm | | 125 μm | | 450 μm | |
| Fiber zero | 1210 | nm | Nonexistent | | 1260 | nm |
| dispersion | | | | | | |
| wavelength | | | | | | |
| Focusing length, | 18.4 mm, C280TMD- | | 3.1 mm (C330TME- | | 50 mm, AC127-050- | |
| lens (vendor) | B (Thorlabs) | | B (Thorlabs) | | B (Thorlabs) | |
| Coupled efficiency | 75% | | 70% | | 79% | |
| Coupling (output) P | 1.2 | W | 0.22 | W | 3.44 | W |
| Input peak intensity | 5 | TW/cm² | 5 | TW/cm² | 6 | TW/cm² |
| Collimating | focal length | | focal length | | focal length | |
| parabolic mirror | 25 mm | | 10 mm | | 50 mm | |
| Output PER | >50 | | >50 | | >30 | |
| Long-term fiber | present after 100 ± 40 | | present after 10 ± 2 | | absent after >1000 | |
| photodamage | hrs accumulative | | hrs accumulative | | hrs accumulative | |
| | operation | | operation | | operation | |
| Number of fiber | 18 | | 7 | | 2 | |
| pieces | | | | | | |
| Fiber length | 25 | cm | 25 | cm | 9.0 | cm |
| Localization of | <10 cm beyond fiber | | <1 cm beyond fiber | | Not observed | |
| photodamage | entrance end | | entrance end | | | |
| Estimated Λ | 1 | mm | 80 | μm | ~9 | cm |
| of LPFG | | | | | | |

*Pulse width of sech²-shape from two similar lasers (Satsuma 10W, Amplitude) with a beam diameter of ~1.8 mm.

It can be seen from Table 3 that, for Scheme 1, each piece encountered a long-term photodamage after accumulative operation of 100±40 h. resulting in gradually reduced (up to 10%) coupling efficiency not compensable by optical realignment along with narrowed spectral broadening and often degraded output beam quality. This fiber photodamage was observed in another polarized supercontinuum source, except for the use of a non-FCPA operated at 40 MHZ as the master laser (Table 3, Scheme 2). Although Scheme 2 matched Scheme 1 in input peak intensity (see Table 3), the resulting supercontinuum produced a broader spectrum due to the lower dispersion of the fiber (FIG. 1, inset (b), bottom). However, photodamage with gradually reduced coupling efficiency was found to occur in a shorter timeframe of 10±3 h (see Table 3), so that the stain-free histopathology had to replace the fiber daily to obtain reproduceable results. This photodamage required replacement of the fiber with tedious optical realignments and thus limited the femtosecond biophotonic application of both schemes of supercontinuum source.

While not wishing to be confined to any one theory of operation, a difference between the two schemes was identified. The photodamage in Scheme 2 was localized within 1-cm beyond the entrance end of the fiber, as re-cleaving of this length for a damaged 25-cm fiber piece would recover the fiber coupling efficiency and supercontinuum bandwidth. In contrast, the photodamage in Scheme 1 was relatively delocalized, as re-cleaving up to 10-cm length beyond the entrance end of a damaged 25-cm fiber piece was needed to recover the fiber coupling efficiency. The observed localization of fiber photodamage and reduced coupling efficiency over time are inconsistent with airborne contamination in a non-clean-room environment and/or high peak-intensity free-space coupling. The former would lead to rather sudden or random reduction of the coupling efficiency while the latter spatiotemporally similar photodamage for the two schemes. Thus, it is unlikely to mitigate the photodamage by specific fiber end-capping with mode expansion (FIG. 1, Approach 2).

The observed photodamage in Scheme 2 supports the interpretation based on the emergence of a photoscattering waveguide at the fiber entrance end in the form of long-period fiber grating (LPFG). In this interpretation, the input pulse propagating in the core mode beats with the copropagating pulse in a cladding mode after free-space-to-fiber coupling to produce the standing wave that writes and progressively strengthens a long-period fiber grating (LPFG). The period (Λ) of this LPFG is determined by the phase matching of Λ=λ/[n_{co}(λ)−n_{cl}(λ)], where λ is the central wavelength of the pulses while n_{co}(λ) and n_{cl}(λ) are the corresponding effective refractive index of the core mode and cladding mode, respectively. The pulses have broad bandwidths (˜10 nm for 280 fs input and larger along the fiber for the core mode due to supercontinuum generation) from which the blue and red edges write slightly different grating periods and lead to the localized LPFG formation at the entrance end (because the superposition of the gratings from different wavelengths can be in phase for a limited length). The temporal walk-off between two pulses may also contribute to this localized LPFG formation.

For a given λ, the period Λ of a circular fiber can be calculated from the dielectric structure of fiber cross section. Similarly, Λ of a photonic crystal fiber can be calculated from the pitch and hole sizes of fiber cross section (FIG. 1, inset (b)) for the two schemes (see Table 3), if n_{cl}(λ) approximates the effective refractive index of the fundamental space filling mode. The much larger Λ in Scheme 1 as opposed to Scheme 2 is thus responsible for more delocalized fiber photodamage to approach similar LPFG strength (with dozens of periods) or loss of fiber coupling efficiency (10%), and slower LPFG formation via increased spectral broadening (supercontinuum generation) and/or pulse walk-off at longer fiber lengths. As a nontrivial prediction from this interpretation, the LPFG-based photodamage would disappear if the calculated/approaches the total length of the supercontinuum-generating fiber (because the LPFG would function poorly with only one period).

To test this prediction, a third scheme of supercontinuum generation was developed using an ultra-large core silica photonic crystal fiber (LMA-PM-40-FUD, NKT Photonics) that approximates the doped DC-200/40-PZ-Yb fiber in a PP-FCPA laser, with a cross section of large-pitch small-hole lattice (FIG. 1, Approach 3; Table 3, Scheme 3). The selection of a short fiber length (9.0 cm) not only avoided undesirable bending effect or depolarization effect, but also approached the calculated 4 from this fiber (Table 3). Without the fiber end-capping (Approach 2), the resulting supercontinuum source (see FIG. 1, inset (b), Scheme 3) remained stable after >2000 h of accumulative operation within 2 years in a regular (non-clean-room) optical laboratory. This test validates the LPFG-based interpretation of fiber photodamage. Besides the suppression of the LPFG photodamage, the large core size (40 μm) also scales up the peak power for tunable pulse generation (see below), just like that for non-dissipative and dissipative soliton pulses.

The dependence of supercontinuum spectrum (Table 3, Scheme 3) on f of the master PP-FCPA laser at the same E (i.e., P/f) was also examined. The laser/input spectrum and t was independent of f, so that the supercontinuum output retained similar spectrum across wide f range of 2-10 MHZ (FIG. 1, inset (c), top). This deterministic generation of coherent fiber supercontinuum relates to the fact that the spectrum can be theoretically predicted if the spatiotemporal property of input laser pulse is known. Similar f-independent spectra were obtained at lower E, so that the leftmost and rightmost spectral lobes may be filtered to generate compressed pulses across 950-1110 nm, wherein they converge at 1030 nm (FIG. 1, inset (c), bottom). The observed f-independent supercontinuum generation resembles that of soliton generation.

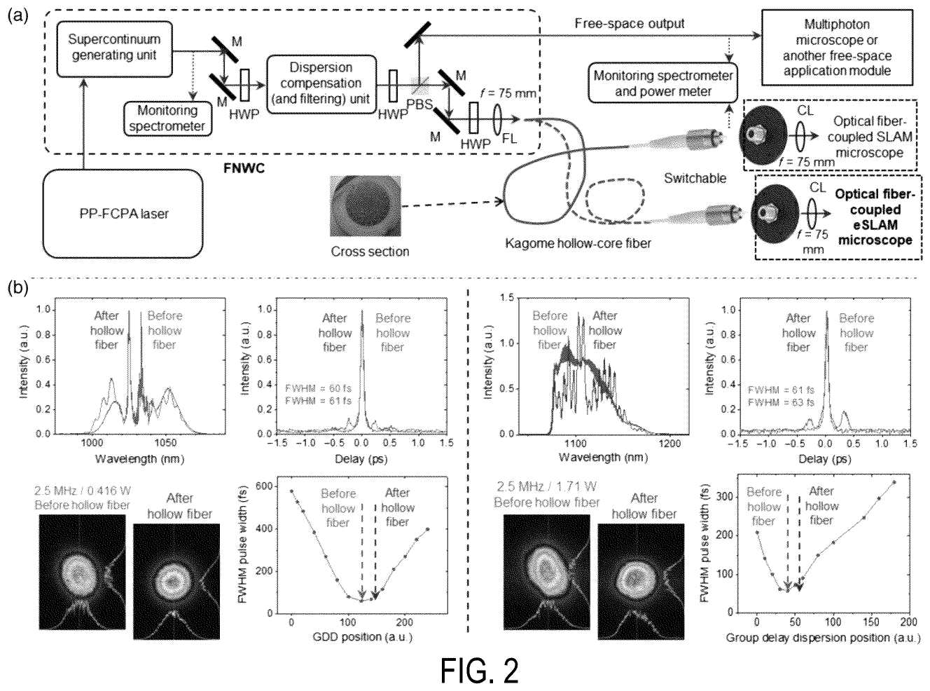

Experimentally, collimated fiber supercontinuum output was aligned along the horizontal polarization by an achromatic half-wave plate to enter a pulse dispersion compensation unit (see FIG. 2, inset (a)) in the form of programmable pulse shaper (FemtoJock, Biophotonic Solutions), which was empowered by multiphoton intrapulse interference phase scan (MIIPS) through a 128-pixel spatial light modulator (SLM). The pulse shaper spectrally selected a fixed-bandwidth window (˜60 nm) inside the supercontinuum spectrum with a tunable central wavelength across 950-1110 nm after motorized rotation of the reflective grating of the pulse shaper to project this spectral window on the SLM. For a pulse centered at λ=1030 nm without the spectral lobe filtering or at a detuned λ (e.g., 1110 nm) with this filtering, the pulse shaper allowed compressing this pulse close to its transform limit τ (˜60-fs FWHM or ˜40-fs sech²-shape) and chirping/tuning the pulse to ˜400 fs (FIG. 2, inset (b)).

In particular, FIG. 2 illustrates, at inset (a), schematics of a FNWC and related optical components for femtosecond biophotonics switchable between different microscopes or applications by fiber-optic telecommunication connection and disconnection. In FIG. 2, as in FIG. 1, PP-FCPA refers to a pulse-picked fiber chirped pulse amplifier, BB refers to a beam blocker, M refers to a mirror, HWP refers to a halfwave plate, PBS refers to a polarizing beam splitter, FL refers to a focusing lens, and CL refers to a collimating lens. Inset (b) of FIG. 2 illustrates FNWC output spectrum (1030-nm central wavelength without filtering the supercontinuum), pulse width, spatial mode/profile, and full width at half maximum (FWHM) pulse width versus group delay dispersion (GDD) position before and after 1-m Kagome hollow-core fiber (left), in comparison to FNWC output spectrum (1110-nm central wavelength from filtered supercontinuum), pulse width, spatial mode/profile, and FWHM pulse width versus GDD position before and after 1-m Kagome hollow-core fiber (right).

In some examples, the free-space output from the pulse shaper was recoupled into a 1-m low-dispersion Kagome hollow-core fiber patch cable (PMC-C-Yb-7C, GLOphotonics) by an achromatic lens of 75-mm focal length, with slightly λ-dependent efficiency of 76±3%. The weak birefringence intrinsic to the hollow-core fiber allowed rotating the input polarization by a half-wave plate to maximize the PER of fiber-delivered output to 10-20, depending on the bending state of the fiber. The spectrum and spatial beam profile of fiber-delivered output after the collimation by an achromatic lens (75-mm focal length) approximated those of the free-space input before the fiber, while the small pulse duration of free-space input was largely retained (FIG. 2, inset (b)). At the cost of 24% lower P or E and slightly degraded PER, the fiber pulse delivery gains several advantages over free-space pulse delivery: i) simple fiber telecommunication connection and disconnection allows easy switching among different optical fiber-coupled application modules, i.e. sharing the fiber delivered output among these modules (FIG. 2, inset (a)); ii) fiber delivery of energetic pulses is safer than free-space delivery for operators without extensive laser training; iii) the fiber recoupling condition of endless single-mode fiber supercontinuum is independent on λ (i.e., rotation of the grating in the pulse shaper), which can be useful to monitor and correct the misalignment of the pulse shaper itself in portable application of this tunable source (beyond an environmentally controlled laboratory).

The SLM-based pulse shaper may be omitted from the tunable fiber supercontinuum source with or without hollow-core fiber delivery when only tunable-r pulse generation (rather than arbitrary pulse shaping) is needed. A more cost-effective alternate of single-prism pulse compressor (BOA-1050, Swamp Optics) was tested and generated similar tunable-λ ˜ 40-fs (sech²) pulse by motorized rotation of the prism and the linear motion of a back retroreflector that varies group delay dispersion (GDD) (see Table 4), indicating that the chirp of this fixed bandwidth pulse is largely linear. Due to the fiber input (supercontinuum generation) and, in some implementations, fiber output (dispersion-free pulse transmission through the hollow-core fiber) of the dispersion compensation unit, the whole device may be referred to as a fiber-optic nonlinear wavelength converter (FNWC) (see Table 4). The described FNWC may be generalized to other pp-FCPA lasers (Table 1) with f-independent emission spectrum (FIG. 1, inset (c), top). In contrast to commercial alternatives such as an OPA or OPO, FNWC can independently and widely tune λ, f, and τ (Tables 4 and 5).

TABLE 4
Comparison of FNWC with OPA as accessory for pp-FCPA lasers

| | FNWC (SLM or | |
|---|---|---|
| Accessory | prism compression)* | OPA |
| λ - tunable range (nm) | 950-1110 | Wide |
| f - variable range (MHz) | 1-10 | <5 (typically fixed) |
| τ - tunable range (fs) | 40-400 | ~70 (typically not tuned) |
| P in MW (E in nJ) | 20-200 (20) | up to 1000 (up to 250) |
| Independently tuned λ, f, and τ | demonstrated | not demonstrated |
| Fiber delivered output | demonstrated | non demonstrated |
| Portability/troubleshooting | possible/simple | limited/complex |

*Performance is from Satsuma 10W (Amplitude) and can be further improved for f and P using Satsuma 20W.

TABLE 5
Comparison of integrated pp-FCPA-FNWC laser
with tunable solid-state femtosecond lasers

| | | Tunable solid-state |
|---|---|---|
| | pp-FCPA-FNWC laser | femtosecond lasers |
| Tunable λ range (nm) | 950-1110 | 690-1020 (Ti:sapphire) or |
| | | 690-1300 (OPO) |
| Other tunable pulse | τ (down to ~40 fs) and | τ (typically, down to ~100 fs), |
| parameters | f (1-10 MHz in this study) | f of ~80 MHz typically not |
| | | tunable |
| E and P | high and moderate, | moderate and high, |
| | respectively | respectively |
| Dependence of f on λ | no | yes (even though small) |
| Beam pointing stability | ensured by endless single- | ensured by feedback beam- |
| | mode supercontinuum | pointing correction |
| | (intrinsic) | (extrinsic) |
| Cooling | air cooling sufficient | water cooling required |
| Maintenance cost | low | high |
| Comments on multiphoton | missing 2-photon excitation | often sufficient by 2-photon |
| excitation of common | across 690-950 nm can be | excitation across 690-1020 |
| fluorophores | recovered by 3-photon | nm, except for some with red- |
| | excitation across | shifted emissions across |
| | 690-950 nm | 1020-1300 nm |

Further modifications may be made to the FNWC technology. Broader bandwidths of fiber supercontinuum generation at high input powers may be possible if the multimodal behavior at longer wavelengths (>1120 nm) and the bleed-through of long-wavelength tail of supercontinuum into fiber anomalous dispersion regime (>1250 nm, Table 3) would not degrade single-mode coherent supercontinuum generation. Also, silica photonic crystal fibers with even larger core, e.g., 100 μm (SC-1500/100-Si-ROD, NKT Photonics), may further increase the peak power for supercontinuum generation and the resulting FNWC output while restricting the LPFG-based photodamage. Finally, such modifications may benefit from the improvement of hollow-core delivery fibers on single-mode low-loss transmission, bending tolerance, and polarization maintaining.

The fiber delivery of spectrally filtered fiber supercontinuum pulses as set forth herein excels at user-friendly and cost-effective operation. First, for pulse parameters (A, f, and r) of choice, spectrally monitoring the corresponding deterministically generated fiber supercontinuum ensures day-to-day reproducible optical alignment before the FNWC. Second, for a preselected spectrum of fiber supercontinuum, power (and possibly PER), and modal content ensures day-to-day reproducible optical alignment before the application modules. Third, the fiber-optic telecommunication-based connection and disconnection of the delivery fiber not only ensures the benefit of laser-microscope alignment decoupling, but also enables simple switching or sharing of an integrated PP-FCPA-FNWC laser among different microscopes or applications.

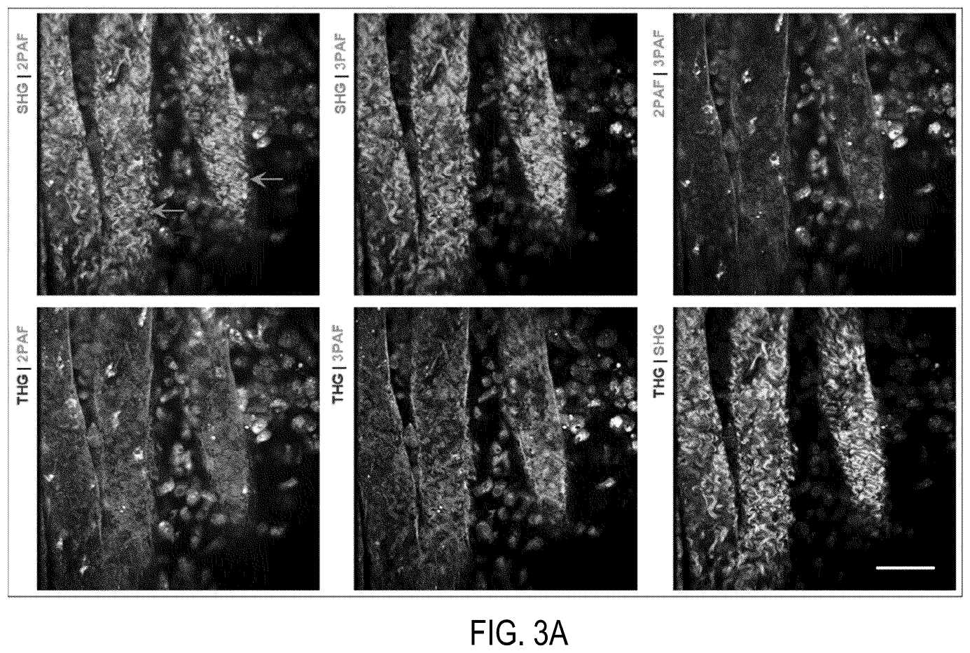

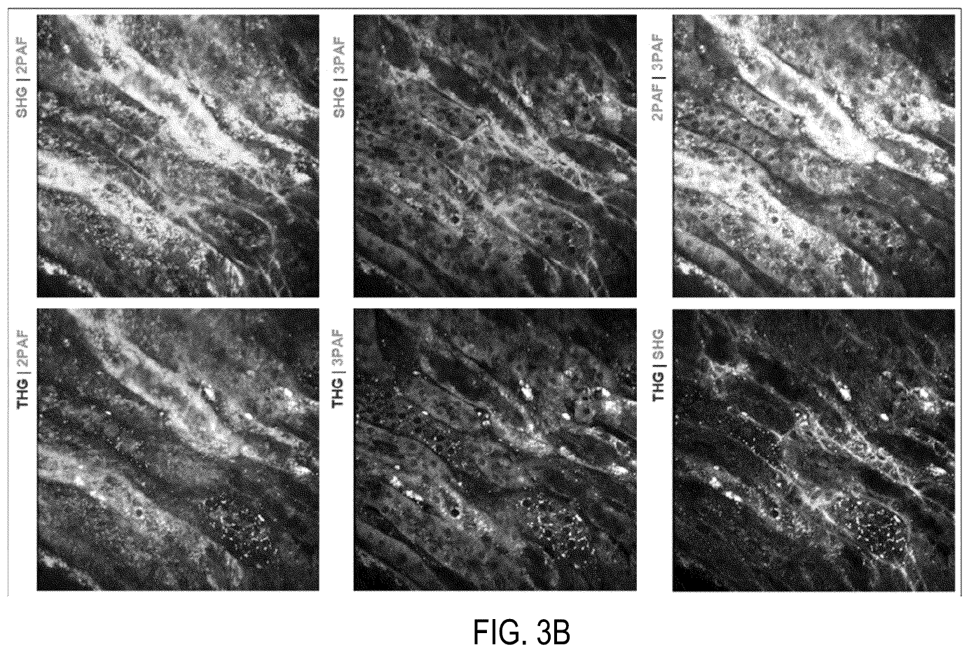

To test the FNWC in multiphoton microscopy, a laser-scanning inverted microscope was modified for simultaneous label-free autofluorescence multi-harmonic (SLAM) imaging, by replacing the scanner based on two galvanometer mirrors with a 1592.3-Hz resonant mirror (SC30, Electro-Optical Products) and a regular galvanometer (GVS011, Thorlabs), and replacing the photon-counting photomultipliers with analog-detection photomultipliers (H7422-40A, Hamamatsu). The data acquisition hardware and software were also modified to accommodate these changes. The fiber-delivered FNWC output (1110 nm, 5 MHz, 40-fs) into this modified SLAM microscope enabled high-performance imaging, confirming the good beam quality from the fiber delivered output (see Table 4). FIGS. 3A and 3B illustrate label-free SLAM images with a resolution of 1024×1024 pixels and a 17 s total acquisition time. In particular, FIG. 3A illustrates ex vivo rabbit intestine tissue and FIG. 3B illustrates ex vivo rabbit kidney tissue, both excited by fiber-delivered FNWC output, with colored contrasts of second-harmonic generation (SHG), third-harmonic generation (THG), two-photon-excited auto-fluorescence (2PAF), and three-photon-excited auto fluorescence (3PAF) showing live cells (arrowheads) and extracellular matrix (arrows). The scale bar is 50 μm.

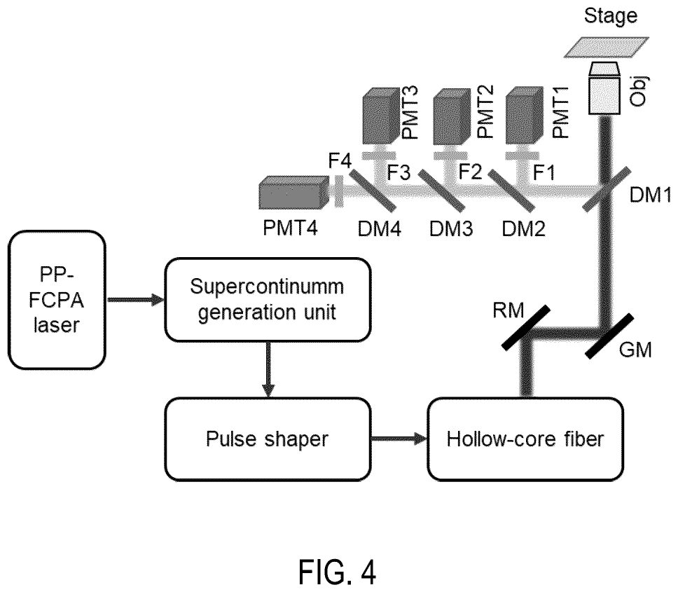

In another example, the supercontinuum source (see Table 3, Scheme 1) of the SLAM microscope was replaced with the FNWC (see Table 3, Scheme 3) and the fiber-delivered pulses were collimated by an achromatic lens as a free-space beam input to the microscope. By operating the FNWC at the modified illumination of SLAM imaging that integrates four modalities of two- and three-photon excited autofluorescence and harmonics (2PAF, SHG, 3PAF, and THG; see Table 6), it was possible to reliably visualize live samples, such as ex vivo rodent tissue. The plausible high-order mode coupling and related side-pulse generation in the delivery fiber did not significantly degrade the imaging performance, as also demonstrated in multiphoton microscopy with Kagome hollow-core fiber delivery of Ti:sapphire laser pulses. However, the FNWC retains stable output after >2000 h (and counting) of cumulative operation without replacing the supercontinuum generating photonic crystal fiber, providing an improvement over the base SLAM microscope. Beyond base SLAM imaging with long-term stability, FNWC can adapt to evolving research needs, such as high temporal-resolution intravital imaging and high-throughput fluorescence lifetime imaging microscopy (FLIM), by tuning the illumination (i.e., repetition rate from 10 to 5 MHz) and building an extended SLAM (“eSLAM”) microscope with a fiber-coupled input. FIG. 4 illustrates an example of the eSLAM platform.

TABLE 6
Complementary features of base SLAM imaging
and eSLAM imaging that share one FNWC

| | Base SLAM | eSLAM |
|---|---|---|
| Pulse repetition rate | 10 MHz (≤17 mW*) on | 5 MHz (≤17 mW*) on |
| (average power) | sample | sample |
| Photonic crystal fiber | LMA-PM-15, NKT Photonics | LMA-PM-40-FUD, NKT |
| (lifetime) | (~100 h) | Photonics (>2000 h) |
| Optical scanner; | Galvo-Galvo (6215 H, | Resonant (SC30, Electro- |
| fast-axis | Cambridge Technology); | Optical Products) and Galvo |
| line rate | up to 350 Hz | (GVS011, Thorlabs); 1592 Hz |
| Pulse number per | 50-120 | 1 |
| pixel per frame | | |
| Photodetection mode | Photon counting | Analog sampling (2 GHz |
| | | for 2PF/3PF; 125 MHz |
| | | for SHG/THG) |
| PMT1-THG, quantum | H7421-40 (Hamamatsu), | H10721-210 (Hamamatsu), |
| efficiency | 20.4% | 42.4% |
| PMT2-3PAF, quantum | H7421-40 (Hamamatsu), | H7422A-40 (Hamamatsu), |
| efficiency | 31.8% | 42.1% |
| PMT3-SHG, quantum | H7421-40 (Hamamatsu), | H10721-20 (Hamamatsu), |
| efficiency | 33.4% | 16.8% |
| PMT4-2PAF, quantum | H7421-40 (Hamamatsu), | H7422A-40 (Hamamatsu), |
| efficiency | 31.6% | 41.4% |
| Peak quantum efficiency | H7421-40: 580 nm | H7422A-40: 580 nm |
| wavelength of PMT | | H10721-20: 630 nm |
| | | H10721-210: 400 nm |
| Frame size (FOV) | 700 × 700 pixel | 1024 × 1024 pixel |
| | (≤300 × 300 μm) | (250 × 250 μm) |
| Pixel dwell time (μs) | 2-10 (20-100) | 0.2 (1) |
| (pulses/pixel/frame) | | |
| Frame illumination/ | 1-5 | 0.33/1.37 |
| acquisition time (s) | | |
| Average output power after | 50 | 200 |
| pulse shaper (mW) | | |
| Raw data acquisition | Enabled by a | Enabled by a GPU (GeForce |
| for real-time display | regular CPU | RTX 2080, NVIDIA) |
| and storage | | |
| Strength | Low detection noise and | High temporal resolution with |
| | flexible optical scanning | FLIM capability |
| Other aspect | Low temporal resolution may | Large detection noise and |
| | be worsened by FLIM | inflexible optical scanning |
| Potential application | Quantitative live-cell imaging | Imaging dynamically moving |
| | for drug discovery, label-free | live samples, label-free |
| | imaging with weak signals, | imaging with moderate |
| | small-scale optical biopsy, etc. | signals, labeled imaging, |
| | | large-scale optical biopsy, etc. |

*Limited by phototoxicity. Common features: illumination band: 1110 nm ± 30 nm; pulse width on sample: 60 fs (FWHM); microscope objective: UAPON40X340 (Olympus); NA: 1.15 water immersion.

Compared to base SLAM, the comparatively slow flexible optical scanner and four photon-counting photomultipliers are replaced with a comparatively fast inflexible scanner and four analog-detection photomultipliers that enable FLIM via single-photon peak event detection. As shown in FIG. 4, femtosecond pulses emitted by the PP-FCPA laser are coupled into a large-core PCF to generate a supercontinuum. A pulse shaper is used to select the excitation window and compensate for the dispersion so that the output pulse reaches the near-transform-limited at the sample, and then is coupled into the hollow-core fiber for imaging. In FIG. 4, RM refers to a resonant mirror, GM refers to a galvo mirror, DM refers to a dichroic mirror, Obj refers to an objective, and F refers to a filter. DM1-DM4 edges are, respectively, 925 nm, 376 nm, 484 nm, and 580 nm. F1-F4 spectral bands are, respectively, 365-375 nm, 417-477 nm, 543-566 nm, and 593-643 nm. Other details are found in Table 6. The mode-locking electronic signal was used as the master clock to synchronize optical scanning and subsequent signal acquisition.

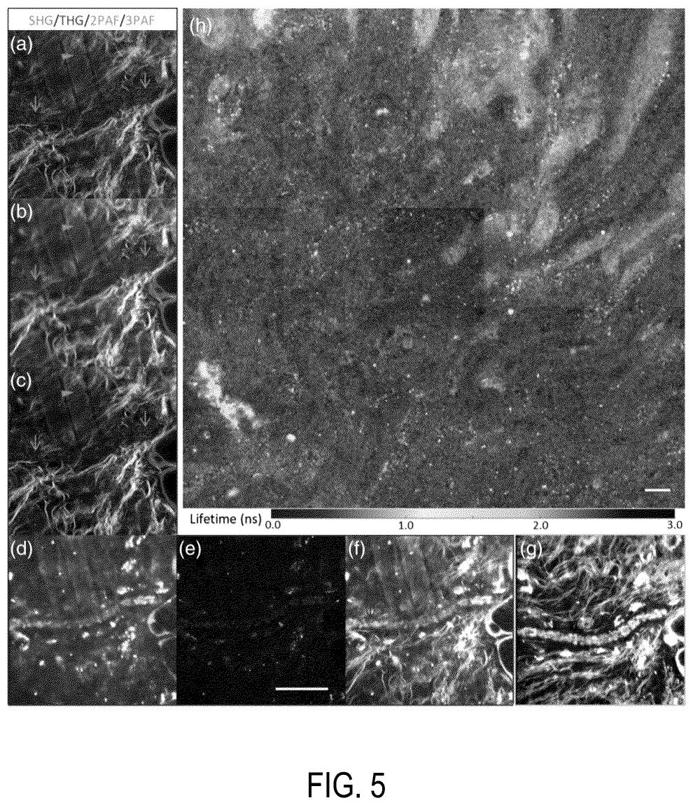

FIG. 5 shows images captured using eSLAM imaging. The increased speed of eSLAM over base SLAM imaging lowered the excitation cycle to the minimum of 1 pulse per pixel per frame (see Table 6), and thus limited the SNR in the intravital imaging of a mouse skin flap with THG-visible flowing blood cells (FIG. 5, image (a), arrows) along with SHG-visible collagen fibers and periodic sarcomeres along muscle myofibrils (FIG. 5, image (a), arrowhead). This low SNR is encountered in real-time nonlinear optical imaging free of labeling and phototoxicity. With the use of machine-learning models such as DeepCAD-RT, the SNR can be improved considerably, but at the cost of the ability to track individual blood cells (see FIG. 5, image (b), arrows) and resolve the periodic sarcomeres (see FIG. 5, image (b), arrowhead). In contrast, another machine-learning model such as UDVD may provide considerably improved SNR and also recover this ability (see FIG. 5, image (c)). This may indicate that certain machine-learning models may be preferable for intravital imaging of dynamically moving samples.

To examine the effects of such models, two self-supervised denoising models (i.e., DeepCAD-RT and UDVD) were used for eSLAM video denoising. Individual channels (SHG, THG, 2PAF, and 3PAF of the low-SNR videos were used to train the models separately for 100 epochs. To quantity the noise level for the whole video without noise-free ground truth, SNR was defined as μ/σ, where μ is the mean pixel value and σ is the corresponding standard deviation. SNR was measured across all frames in the original and denoised videos. The machine learning was conducted on a workstation computer equipped with a CPU (Xeon W-2195, Intel), four GPUs (RTX 8000, Nvidia), and 256 gigabytes of memory. The workstation operated on the Ubuntu system, version 18.04. DL-based video denoising and data analysis were conducted using Python, version 3.9. PyTorch, version 1.11.0, was used during the implementation of the denoising models. Scikit-learn, version 0.23.2, was used for the calculation of evaluation metrics. Plots were generated using Matplotlib, version 3.2.2, and Seaborn, version 0.11.0. Other Python libraries, including Numpy, version 1.19.1, Pandas, version 1.1.2, and SciPy, version 1.5.2, were used to assist data analysis.

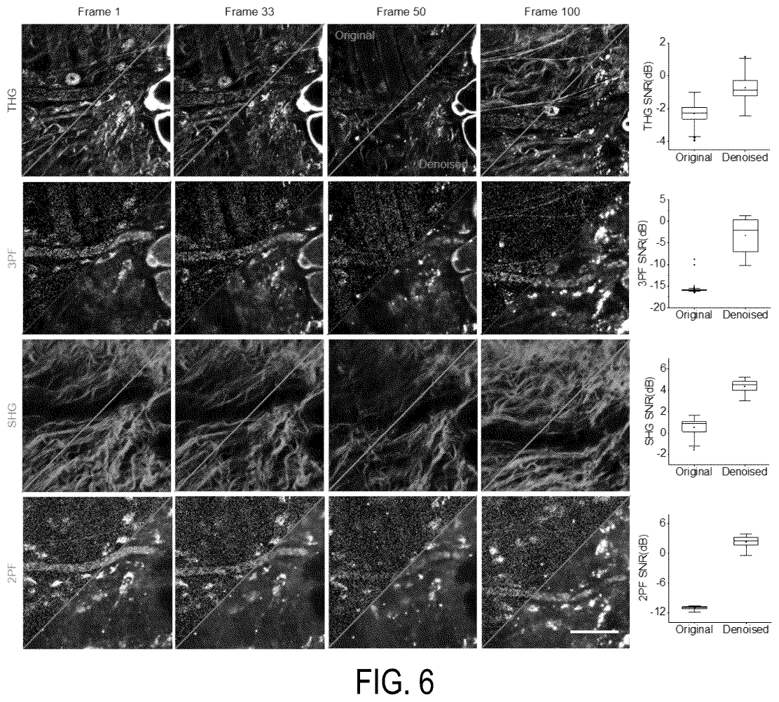

For weaker 2PAF/3PAF signals collected simultaneously, UDVD reveals 2PAF-visible stromal cells (FIG. 5, image (d), arrows) and 3PAF-visible lipids (FIG. 5, image (d), stars) that are otherwise difficult or impossible to discern in the raw data (see FIG. 5, image (c)). This illustrates the larger SNR improvement in comparison to the SHG-THG signals. FIG. 6 further illustrates this effect. In particular, FIG. 6 shows time-lapse intravital eSLAM imaging of mouse skin flap across the modalities of THG, 3PAF, SHG, and 2PAF without (upper left of each image) and with (lower right of each image) UDVD denoising. The box and whisker plots show the corresponding SNR improvement at right. The scale bar represents 50 μm.

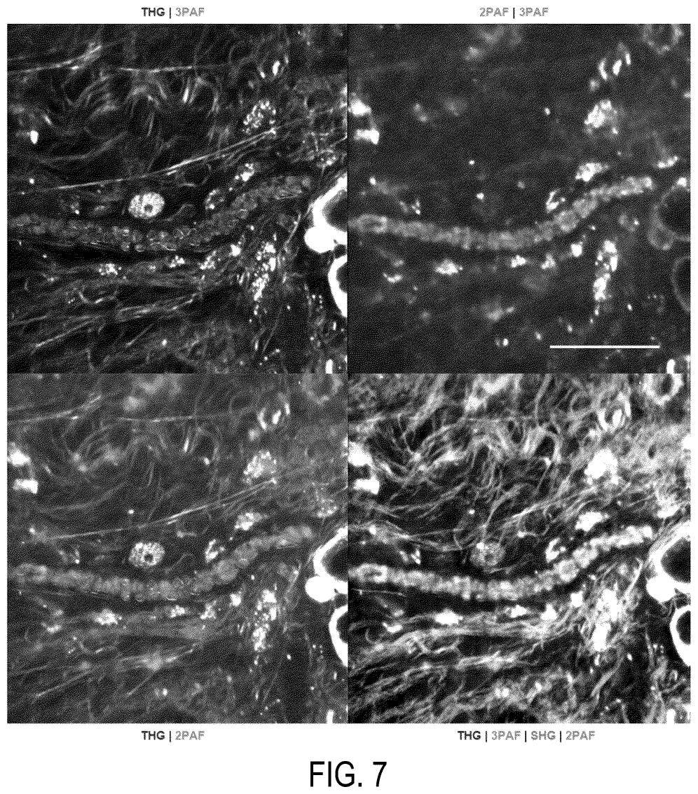

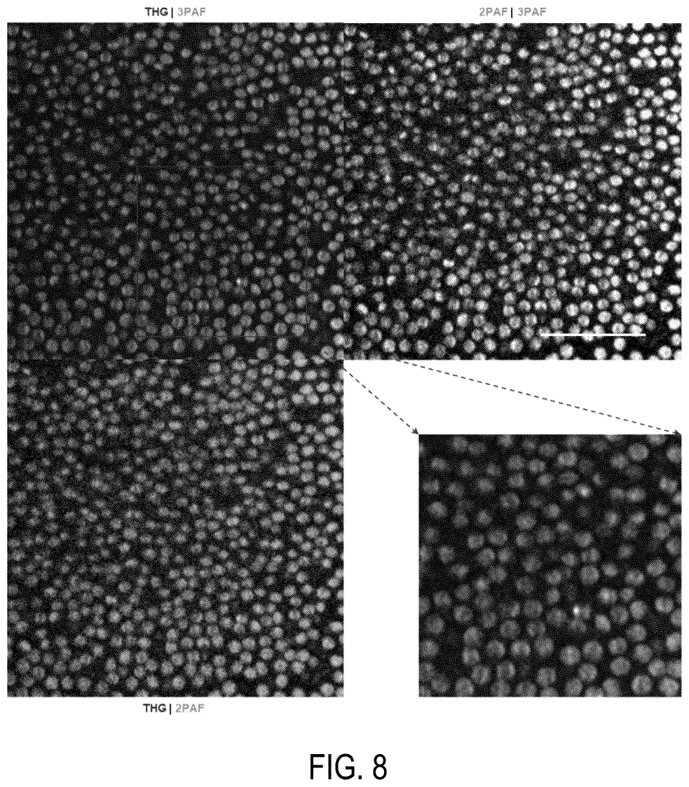

Moreover, in two different instances of imaging, UDVD unambiguously reveals the presence of intracellular 2PAF, 3PAF, and THG signals in different parts of single biconcave disk-shaped blood cells (FIG. 5, images (f) and (g), arrows), which can be confirmed by imaging a fresh blood smear sample. FIG. 7 illustrates intravital eSLAM imaging of mouse skin flap at one instance showing the presence of intracellular 2PAF (yellow), 3PAF (cyan), and THG (magenta) signals in different parts of single biconcave disk-shaped blood cells. FIG. 8 illustrates mouse blood smear from eSLAM imaging, and confirms the presence of 2PAF (yellow), 3PAF (cyan), and THG (magenta) signals in different parts of single blood cells. In both FIGS. 7 and 8, the scale bar represents 50 μm. It can be seen that UDVD benefits all instance of time-lapse cSLAM imaging despite the inevitable sample movement during the imaging. Therefore, the FNWC source can enable real-time visualization of fast biological processes, ensured by the robust, long-lifetime PCF for long-term reliability. Furthermore, tunable parameters including repetition rate, pulse duration, wavelength, and power permit users to identify preferred imaging conditions that improve or maximize the signal-to-photodamage ratio on an application-by-application basis.

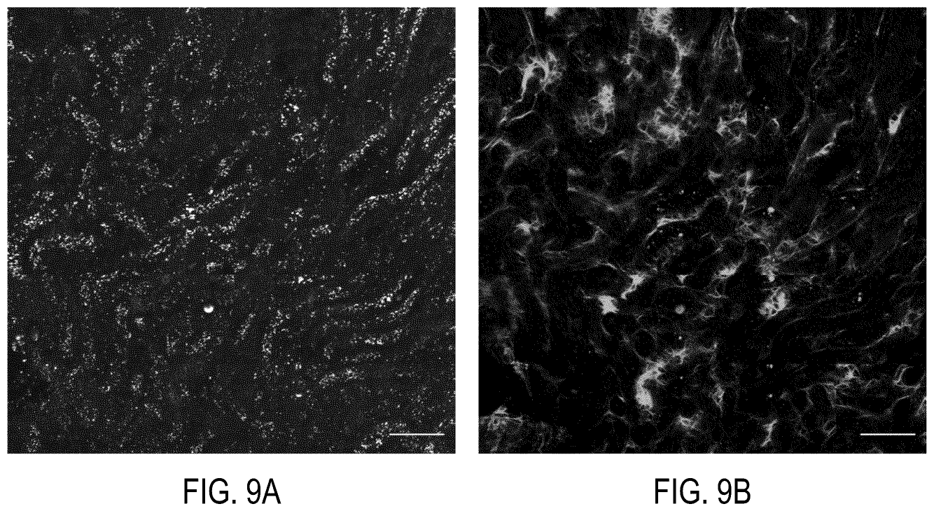

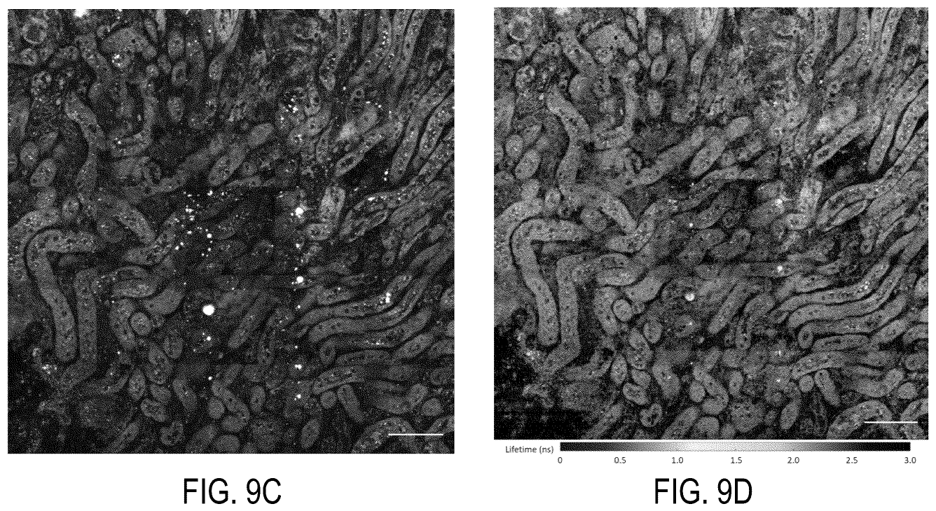

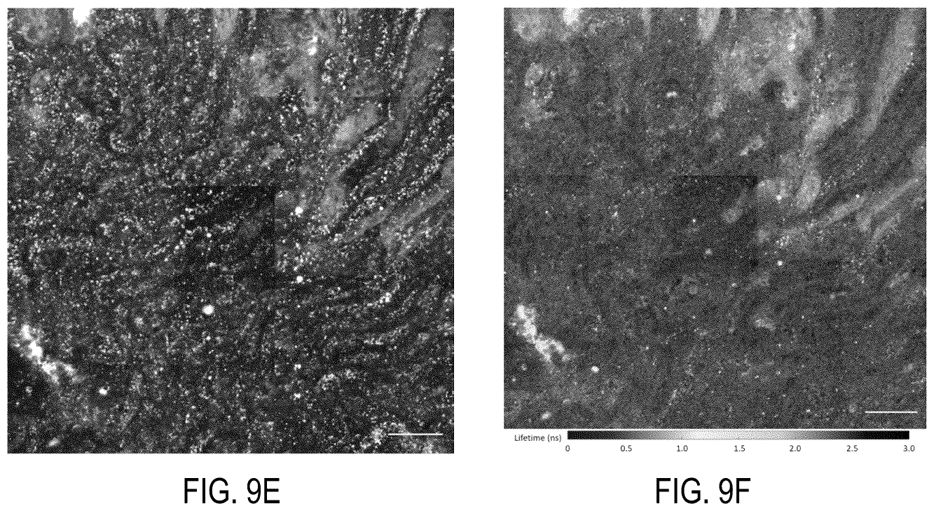

FIGS. 9A-9F show additional images, and demonstrate the high throughput of cSLAM imaging with its built-in FLIM ability in live-tissue pathology. FIG. 9A illustrates a THG image of ex vivo mouse kidney from mosaic eSLAM imaging; FIG. 9B illustrates an SHG image of ex vivo mouse kidney from mosaic cSLAM imaging; FIG. 9C illustrates a 3PAF intensity image of ex vivo mouse kidney from mosaic eSLAM imaging; FIG. 9D illustrates a 3PAF lifetime image of ex vivo mouse kidney from mosaic eSLAM imaging; FIG. 9E illustrates a 2PAF intensity image of ex vivo mouse kidney from mosaic eSLAM imaging; and FIG. 9F illustrates a 2PAF lifetime image of ex vivo mouse kidney from mosaic eSLAM imaging. In each of FIGS. 9A-9F, the scale bar represents 100 μm, and the images are from a large area (1 mm²) of tissue in 30 min. All images involved a 5×5 mosaic of fields of view with an overlapping factor of 20%, which was enabled by an automatic mechanical stage. Among the images, only the 2PAF lifetime image (FIG. 9F) reveals the large-scale vasculature expected from vital kidney tissue that has been visualized at a typical 250×250 μm field of view. It can be seen that some elongated patterns of punctuated points in the 2PAF intensity image (FIG. 9E, arrows) do not co-register with red-colored vasculature in the 2PAF lifetime image (FIG. 9F). Similar large-scale data in a 3D volume were obtained in 12 min to reveal the depth-resolved vasculature. This high-content imaging by FLIM-included eSLAM may help pathologists diagnose diseases from fresh core biopsies or surgical specimens (optical biopsy).

Described here are systems and methods for, in some examples, a tunable ultrafast laser implementing a FNWC suitable for in vivo optical molecular imaging by multiphoton microscopy, which is known for overall good performance in 3D sectioning ability, molecular sensitivity/specificity (via fluorescence), and image content (e.g. field of view, spatial resolution, and depth). The label-free variant of multiphoton microscopy lies at the intersection of fluorescence microscopy, imaging spectroscopy, and label-free nonlinear imaging, which gain multicolor image contrasts at the cost of phototoxicity or photodamage, single-frame acquisition speed or SNR, and complexity or expense of laser source, respectively. Various fields of in vivo imaging and their characteristics are summarized in Table 7.

TABLE 7
Three fields of in vivo optical molecular imaging
and synergy at intersection using FNWC

| | Fluorescence | Imaging | Label-free nonlinear |
|---|---|---|---|
| Field | microscopy | spectroscopy | imaging |
| Background field | bright-field (and | non-spectroscopic | label-free linear |
| | other non- | or single | imaging via phase, |
| | fluorescence) | optical filter- | reflection, |
| | microscopy | based imaging | absorption |
| Tradeoff for multi- | phototoxicity or | single-frame | complexity or |
| contrast | photodamage | acquisition speed | expense of laser |
| | | or SNR | source |
| Avoid trade-off at | spectroscopic inline | supercontinuum-like | fiber-optic |
| intersection | phototoxicity | single-pulse signal | telecommunication |
| | indicator | generation | connection or |
| | | | disconnection |
| Consequential shift | from wide-field to | from discrete optical | from molecular |
| | point-scanning | filters to dispersive | vibration to |
| | | gratings/prisms | fluorescence and |
| | | | harmonics |

* Other metrics: SNR, molecular sensitivity & specificity, 3D sectioning, spatial resolution, depth, FOV, quantitative

The described FNWC may overcome these trade-offs to enable gentle laser-scanning label-free multiphoton imaging spectroscopy at this intersection, by limiting the phototoxicity or photodamage via wavelength-dependent hyper-fluorescence (i.e. spectroscopic inline phototoxicity indicator), by increasing single-frame acquisition speed or SNR via single-pulse broadband signal generation, and by decreasing the complexity or expense of laser source via fiber-optic telecommunication connection or disconnection. This may motivate a shift of fluorescence microscopy from wide-field (or light-sheet) to less popular laser-scanning configuration, a shift of imaging spectroscopy from optical filters and discrete multispectral channels to less used gratings/prisms and continuous color detection (see Table 8), and a shift of label-free nonlinear imaging from molecular vibration to often overlooked auto-fluorescence and harmonics. Without the fiber-coupled delivery, the stable supercontinuum generation portion of FNWC allows programmable label-free contrast generation for multiphoton microscopy.

TABLE 8
Comparison of non-spectral and laser-scanning confocal or multiphoton imaging

| Laser-scanning confocal or | Non-spectral | Spectral |
|---|---|---|
| multiphoton imaging | configuration | configuration |
| Number of spectral | ≤6, typically | ≥16, typically |
| channels | | |
| Separation of individual | by dichroic mirrors and | by a grating- or prism-based |
| spectral channels | optical filters discretely | spectrometer continuously |
| Detector(s) | individual PMT(s) | multichannel PMT, SPAD, |
| | | camera |
| Applicability/strength | predetermined imaging | fast prototyping of live |
| | contents, pseudo-spectral | specimens, spectral |
| | information from fixed | information from tunable |
| | excitation wavelength | excitation wavelength |
| Advantages | simplicity; fast imaging | linear unmixing of multi- |
| | | contrasts; auto-fluorescence |
| | | removal; FRET |

* Performance is from Satsuma 10W (Amplitude) and can be further improved for f and P using Satsuma 20W.

However, the FNWC set forth herein is not limited to label-free imaging. Due to the relatively high-peak power afforded by this device, any deficiency in two-photon excitation of common fluorophores below 950 nm may be compensated by three-photon excitation across 950-1100 nm. Moreover, the tunable aspect of FNWC will enable fast prototyping or optimization of imaging condition not available from alternative lasers. For multiphoton microscopy with photon order n (>1 integer), the signal generation rate scales with Pⁿ/(fτ)ⁿ⁻¹. Thus, a combined low-f and short-τ excitation condition, i.e., a high duty-cycle inverse (fτ)⁻¹, would enhance the signal at a given P, which is limited by laser safety of American National Standards Institute (ANSI). However, one well-known photodamage mechanism also scales with P^{r}/(fτ)^{r-1}, in which the nonlinear order r lies between 2 and 3. Given a two-photon signal of interest (n=2), the mitigation of this highly nonlinear (2<r<3) photodamage demands a low duty-cycle inverse (fτ)⁻¹ because n<r. On the other hand, there exists another popular photodamage mechanism that includes two-photon absorption-induced photochemical damage (r=2) and one-photon absorption-induced photothermal damage (r=1). Because n≥r, the mitigation of this low-r photodamage demands a high duty-cycle inverse. Thus, the flexibility in f and r is needed to appropriately select the signal-to-photodamage ratio for two-photon microscopy, depending on specific biological samples and photodamage mechanisms.

By implementing modern machine-learning models, such as UDVD and DeepCAD-RT, this selection may emphasize low photodamage more than a high SNR, and can be performed in a user-friendly and cost-effective manner by the tunable FNWC with fiber delivery of spectrally filtered fiber supercontinuum pulses, as set forth herein. For free-space output, the stable supercontinuum generated by FNWC allows programmable label-free contrast generation for gentle multiphoton microscopy. Machine-learning models may be selectively implemented depending on factors such as the computational resources required for model training and inference, as well as the potential need for extensive training data to accurately predict preferred conditions across diverse samples. Specific denoising models also come with tradeoffs to be considered in such implementation. For example, UDVD has superior denoising performance, but has low training and inference speed due to the pixel-wise prediction processing. Thus, UDVD may be preferable for post-processing implementations as opposed to real-time-processing implementations. Nonetheless, self-supervised denoising approaches, such as those demonstrated above, do not rely on high-SNR ground truth for training, making them readily applicable to numerous microscopic video restoration tasks.

One enabling feature of FNWC is the unexpected suppression of the long-term fiber photodamage in coherent supercontinuum generation using a photonic crystal fiber with large-pitch small-hole lattice. With this characteristic, one laser source can serve both the base SLAM and eSLAM microscopes, which complement each other in different imaging applications. One potential reason for selecting a comparatively low repetition rate for both imaging systems is that it allows for achieving high peak power in pulses without increasing the average power, thereby reducing potential thermal damage and improving excitation efficiency. Additionally, the choice of specific repetition rates is influenced by the requirements of specific biological applications, such as the potential necessity for labeling and/or imaging speed. Once the corresponding optics are prealigned, the switch between the two types of imaging can be done by a simple connection and disconnection of optical telecommunication within seconds or minutes (see FIG. 2, inset (a), lower right), without any effort of optical realignment. Meanwhile, reproducible laser operation can be ensured by inline monitoring spectrometers and/or a power meter.

The impact of the described FNWC may be extended to other (e.g., nonimaging) areas of femtosecond biophotonics (e.g. precision surgery, optogenetics, and laser tweezer) to address the unmet needs of: i) a laser source widely and independently tuned in λ, f, and τ with sufficient P or E; ii) the extensive use of optical fibers robust against environmental perturbations that permits portable access to tunable ultrafast laser technology outside an environmentally controlled laboratory; and iii) optical fiber-delivered output that allows safe access to high-irradiance laser pulses by diverse users working in real-world situations but without extensive laser training (e.g., field biologists, neuroscientists, veterinarians, surgeons, and pathologists).

Although the invention has been described and illustrated in the foregoing illustrative aspects, it is understood that the present disclosure has been made only by way of example, and that numerous changes in the details of implementation of the invention can be made without departing from the spirit and scope of the invention, which is limited only by any allowed claims that are entitled to priority to the subject matter disclosed herein. Features of the disclosed aspects can be combined and rearranged in various ways.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such aspects or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its aspects.

What is claimed is:

1. An optical source, comprising:
a supercontinuum generating unit including a photonic crystal fiber having, in cross-section, a lattice of holes respectively separated by a pitch, wherein the pitch is three or more times greater than a diameter of the holes, and wherein a length of the photonic crystal fiber is approximately equal to a period of a long-period fiber grating of an input end of the photonic crystal fiber defined by its cross section;
a pulse shaper or dispersion compensation unit configured to shape or compress an output pulse of the supercontinuum generating unit; and
an optical output configured to generate an output radiation.

2. The optical source of claim 1, wherein
the supercontinuum generating unit is configured to receive an input radiation from a laser source, and
the output radiation has a wavelength that is different from a wavelength of the input radiation.

3. The optical source of claim 2, wherein the laser source is a pulse-picked fiber chirped pulse amplifier laser.

4. The optical source of claim 1, wherein a core diameter of the photonic crystal fiber is greater than or equal to 25 μm.

5. The optical source of claim 1, wherein
the supercontinuum generating unit is configured to receive an input radiation from a laser source, and
the optical source is configured to independently tune a wavelength of the output radiation, a repetition rate of the output radiation, and a pulse duration of the output radiation.

6. The optical source of claim 1, wherein the period of the long-period fiber grating is a function of a wavelength of an input radiation to the photonic crystal fiber, an effective refractive index of a core mode of the photonic crystal fiber, and an effective wavelength of a cladding mode of the photonic crystal fiber.

7. The optical source of claim 1, wherein the optical output is coupled to a hollow-core fiber.

8. A microscopy system, comprising:
a laser source configured to generate an input radiation;
a nonlinear wavelength converter including:
a supercontinuum generating unit configured to receive the input radiation, the supercontinuum generating unit including a photonic crystal fiber having, in cross-section, a lattice of holes respectively separated by a pitch, wherein the pitch is three or more times greater than a diameter of the holes, and wherein a length of the photonic crystal fiber is approximately equal to a period of a long-period fiber grating of an input end of the photonic crystal fiber defined by its cross section,
a pulse shaper or dispersion compensation unit configured to shape or compress an output pulse of the supercontinuum generating unit, and
an optical output configured to generate an output radiation; and
a hollow-core fiber configured to optically couple the output radiation to an optical device.

9. The microscopy system of claim 8, further comprising the optical device, wherein the optical device is a simultaneous label-free autofluorescence multi-harmonic (SLAM) microscope or an enhanced SLAM (eSLAM) microscope.

10. The microscopy system of claim 9, further comprising a processing device configured to receive an image generated by the optical device, wherein the processing device includes at least one processor operatively connected to a memory.

11. The microscopy system of claim 10, wherein the processing device is configured to apply a machine-learning model to the image and generate a modified image, wherein a signal-to-noise ratio (SNR) of the modified image is higher than an SNR of the image.

12. The microscopy system of claim 11, wherein the machine-learning model is a self-supervised machine-learning model.

13. The microscopy system of claim 11, wherein the image is a frame of a video, and wherein the machine-learning model is configured to generate the modified image in real-time.

14. The microscopy system of claim 8, wherein the optical device is configured to perform at least one of a second-harmonic generation imaging, a third-harmonic generation imaging, a two-photon-excited auto-fluorescence imaging, or a three-photon-excited auto-fluorescence imaging.

15. The microscopy system of claim 8, wherein the hollow-core fiber is configured to physically couple to the optical device via a removable telecommunication-based connector.

16. The microscopy system of claim 8, wherein the output radiation has a wavelength that is different from a wavelength of the input radiation.

17. The microscopy system of claim 8, wherein the laser source is a pulse-picked fiber chirped pulse amplifier laser.

18. The microscopy system of claim 8, wherein a core diameter of the photonic crystal fiber is greater than or equal to 25 μm.

19. The microscopy system of claim 8, wherein the nonlinear wavelength converter is configured to independently tune a wavelength of the output radiation, a repetition rate of the output radiation, and a pulse duration of the output radiation.

20. The microscopy system of claim 8, wherein the period of the long-period fiber grating is a function of a wavelength of the input radiation, an effective refractive index of a core mode of the photonic crystal fiber, and an effective wavelength of a cladding mode of the photonic crystal fiber.
